(19) United States
(12) Patent Application Publication
(10) Pub. No.: US 2024/0186043 A1
(43) Pub. Date: Jun. 6, 2024

(54) POWDER FOR MAGNETIC CORE, METHOD FOR MANUFACTURING SAME, AND DUST CORE

(71) Applicant: AICHI STEEL CORPORATION, Tokai-shi, Aichi-ken (JP)

(72) Inventor: Norihiko HAMADA, Aichi-ken (JP)

(73) Assignee: AICHI STEEL CORPORATION, Tokai-shi, Aichi-ken (JP)

(21) Appl. No.: 18/282,727

(22) PCT Filed: Feb. 28, 2022
(86) PCT No.: PCT/JP2022/008155

§ 371 Date: Sep. 18, 2023

(30) Foreign Application Priority Data
Mar. 19, 2021 (JP) 2021-046370

(51) Int. Cl. H01F 1/24; B22F 1/05; B22F 1/102; B22F 1/142; B22F 1/145; B22F 1/16; B22F 3/00; B22F 3/02; B22F 3/24; C22C 38/02; H01F 27/255

(52) U.S. Cl. CPC H01F 1/24; B22F 1/05; B22F 1/102; B22F 1/142; B22F 1/145; B22F 1/16; B22F 3/004; B22F 3/02; B22F 3/24; C22C 38/02; H01F 27/255; B22F 2003/248; B22F 2301/35; B22F 2998/10; B22F 2999/00; C22C 2202/02

(57) ABSTRACT

A method for manufacturing a powder for magnetic cores includes: a calcination step for heating a first powder composed of an iron alloy containing Si at 975° C. to 1175° C. to obtain a calcined body; a cracking step for disintegrating the calcined body to obtain a second powder; and a powder annealing step for annealing the second powder to obtain a third powder. The powder annealing step is performed, for example, by heating the second powder at 550° C. to 850° C. The third powder is composed, for example, of soft magnetic particles satisfying an average particle diameter of 50 to 250 μm, an average crystal particle diameter of 30 to 100 μm, and an average particle hardness of 100 to 190 Hv. Such a dust core is suitable, for example, when used in an alternating magnetic field having a frequency of 1 to 3 kHz.

### TECHNICAL FIELD

The present invention relates to a method for manufacturing a powder for magnetic cores that is used for manufacturing a dust core, and relates also to relevant techniques.

### BACKGROUND ART

Electromagnetic devices such as electric motors (motors), generators, various actuators, and electric transformers (transformers) apply an alternating magnetic field via a magnetic core (soft magnet). To improve the efficiency of electromagnetic devices, magnetic cores having excellent magnetic characteristics and less high-frequency losses (simply referred to as “iron losses” regardless of the material of magnetic core, hereinafter) are required.

The iron losses include an eddy-current loss, a hysteresis loss, and a residual loss, among which the eddy-current loss increases in proportion to the square of the frequency of the alternating magnetic field. In order to reduce this eddy-current loss, magnetic cores composed of a laminate of magnetic steel sheets whose surfaces are coated with insulation have been mainly used.

Recently, however, attention has focused on dust cores (compacts of soft magnetic particles coated with insulation) that have a high degree of freedom in shape and can reduce not only the eddy-current loss but also the hysteresis loss which increases in proportion to the frequency of the alternating magnetic field. Descriptions related to such dust cores are found in the following patent documents.

### PRIOR ART DOCUMENTS

### Patent Documents

Patent Document 1: JP2004-288983A
Patent Document 2: JP2006-24869A
Patent Document 3: JP2013-142182A
Patent Document 4: JP2016-213306A

### SUMMARY OF INVENTION

### Technical Problem

The dust cores described in the above patent documents are assumed to be used for inductors and reactors, which are used in switching power supplies, DC/DC converters, etc., and the assumed usage frequency regions have been about 10 to 100 kHz.

However, when expanding the use of dust cores to electromagnetic devices used in lower frequency regions (e.g., 1.2 to 3 kHz), it is necessary to further reduce the iron losses (e.g., hysteresis loss), which may be problematic in the lower frequency regions.

The present invention has been made in view of such circumstances, and objects of the present invention include providing a method for manufacturing a powder for magnetic cores that is able to reduce the iron losses (e.g., hysteresis loss) of dust cores.

### Solution to Problem

As a result of intensive studies to achieve the above objects, the present inventor has newly found that the iron losses (e.g., hysteresis loss) of dust cores can be further reduced with the use of a soft magnetic powder obtained by subjecting the raw material powder composed of an iron alloy to high-temperature heating, cracking, and annealing. Developing this achievement, the present inventor has accomplished the present invention as will be described hereinafter.

### «Method for Manufacturing Powder for Magnetic Cores»

(1) The present invention provides a method for manufacturing a powder for magnetic cores. The method includes a calcination step for heating a first powder composed of an iron alloy containing Si at 975° C. to 1175° C. to obtain a calcined body, a cracking step for disintegrating(crushing) the calcined body to obtain a second powder, and a powder annealing step for annealing the second powder to obtain a third powder.

(2) According to the manufacturing method of the present invention, the third powder (soft magnetic powder) composed of powder particles having a large crystal particle diameter and small residual strain and residual stress can be obtained. The use of this third powder enables the manufacturing of a dust core that can reduce at least the hysteresis loss.

### «Powder for Magnetic Cores»

The present invention is also perceived as such a powder for magnetic cores. For example, the present invention may provide a powder for magnetic cores that is composed of an iron alloy containing Si. The powder includes soft magnetic particles satisfying an average particle diameter of 50 to 250 μm, an average crystal particle diameter of 30 to 100 μm, and an average particle hardness of 100 to 190 Hv. The powder for magnetic cores may include soft magnetic particles coated with insulation in order to reduce the eddy-current loss of a dust core (improve the specific resistance of a dust core).

### «Dust Core, etc.»

The present invention is also perceived as a dust core obtained by molding the above-described powder for magnetic cores or as a method for manufacturing such a dust core. The method for manufacturing a dust core may include, for example, a molding step for the powder for magnetic cores and a heat treatment (annealing) step for removing residual strain and residual stress that are introduced into the powder particles during the molding step.

### «Others»

Unless otherwise stated, a numerical range “x to y” as referred to in the present specification includes the lower limit x and the upper limit y. Any numerical value included in various numerical values or numerical ranges described in the present specification may be selected or extracted as a new lower or upper limit, and any numerical range such as “a to b” can thereby be newly provided using such a new lower or upper limit.

Unless otherwise stated, a range “x to y μm” as referred to in the present specification means x μm to y μm. The same applies to other unit systems (such as kHz and kW/m²).

### BRIEF DESCRIPTION OF DRAWINGS

FIG. 1 is photographs showing the state after calcination of raw material powders.

FIG. 2 is micrographs of powder particles disintegrated after calcination.

FIG. 3 is a scatter diagram illustrating the relationship between the average crystal particle diameter of powder particles after calcination and the calcination temperature.

### EMBODIMENTS FOR CARRYING OUT THE INVENTION

The present invention will be described in more detail with reference to one or more embodiments of the invention. One or more features freely selected from the present specification can be added to the above-described features of the present invention. The content described in the present specification can be applied to a powder for magnetic cores, a dust core, a method for manufacturing the powder for magnetic cores, and a method for manufacturing the dust core, all according to the present invention. Features regarding a manufacturing method can also be features regarding a product. Which embodiment is the best or not is different in accordance with objectives, required performance, and other factors.

### Powder and Manufacturing Method

### (1) First Powder

The first powder is composed of an iron alloy (soft magnetic material) containing Si. Si may be contained in an amount of 1 to 4 mass % (simply referred to as “%”) in an embodiment or 2% to 3.5% in another embodiment with respect to 100% of the iron alloy as a whole. An unduly small amount of Si may increase the eddy-current loss and hysteresis loss. An unduly large amount of Si may increase the hardness to deteriorate the moldability. In the present specification, unless otherwise stated, the alloy composition is represented by the mass ratio to the iron alloy as a whole.

The iron alloy may contain Fe and incidental impurities as the balance other than Si and may also contain, in addition to Si, one or more modifying elements (e.g., Mn, Cr, Mo, Ti, Ni, etc.) that can improve the magnetic characteristics, specific resistance, formability, etc. of the dust core. Usually, the amount of modifying elements is small; for example, the total amount of modifying elements is 3% or less in an embodiment or 1% or less in another embodiment relative to the iron alloy as a whole. Part of Fe may be substituted with other ferromagnetic elements (such as Co and Ni).

Methods for manufacturing the raw material powder used as the first powder are not limited. The raw material powder may be an atomized powder or a pulverized powder. The atomized powder may be any of a water atomized powder, a gas atomized powder, and a gas water atomized powder. The use of atomized powder composed of pseudo-spherical particles can reduce the aggressiveness between particles and can also suppress a decrease in the specific resistance value of the dust core (increase in the eddy-current loss) due to insulation breakdown or the like.

The particle diameter of the powder particles is appropriately selected. For example, the average particle diameter is 50 to 250 μm in an embodiment or 75 to 150 μm in another embodiment. If the particle diameter is unduly large, the eddy-current loss of the dust core may increase, while if the particle diameter is unduly small, the hysteresis loss of the dust core may increase.

Unless otherwise stated, the “average particle diameter” as referred to in the present specification is a median diameter (D50: a particle diameter at which the cumulative frequency is 50%) measured using a particle size distribution analyzer (e.g., HELOS & RODOS laser diffraction dry particle size distribution analyzer).

The first powder may be classified (JIS Z2510: 2004) using a sieve with a predetermined mesh size (JIS Z8801: 1982). This can stably reduce the iron losses of the dust core. For example, the raw material powder may be used as the first powder after being classified into 45 to 250 μm in an embodiment, 75 to 212 μm in another embodiment, or 100 to 160 μm in still another embodiment.

### (2) Second Powder

The second powder is obtained, for example, through a calcination step for heat-treating the first powder and a cracking step for disintegrating a calcined body obtained in the calcination step (cracking as used herein includes pulverization). The calcination step may be performed such that the first powder is heated at a temperature and for a time that ensure the occurrence of crystal growth in the powder particles. The heating temperature in the calcination step (referred to as a calcination temperature) is, for example, 975° C. to 1175° C. in an embodiment, 1000° C. to 1125° C. in another embodiment, or 1025° C. to 1075° C. in still another embodiment. The heating time is, for example, 0.4 to 3 hours in an embodiment or 0.7 to 2 hours in another embodiment.

The calcination temperature is a high temperature at which a general green compact (high-pressure molded body of powder) can become a sintered body. Surprisingly, however, the first powder or its low-pressure molded body (pre-molded body/preform, etc.) does not become a sintered body even when heated to a high temperature and remains in a fixed body (calcined body) that can be disintegrated or pulverized. The second powder obtained by disintegrating (and further pulverizing) the calcined body has approximately the same particle shape and average particle diameter as those of the first powder.

The calcination step and the cracking step can be carried out under various atmospheres. When suppressing oxidation (surface oxidation) or the like of the powder particles, these steps may be carried out in an inert atmosphere (inert gas atmosphere such as rare gas or nitrogen gas, hydrogen reduction atmosphere, vacuum atmosphere, etc.). If the surface oxidation of the powder particles is accepted or if the surfaces of the powder particles are intentionally oxidized, the calcination step or the like may be carried out in a desired oxidizing atmosphere.

The cracking step is a step for recovering the calcined body to a powder form, and is carried out for a predetermined period of time using a disintegrator(cracking machine, crusher), pulverizer (grinder), or the like. For example, a ball mill is used in this treatment for about 0.5 to 5 hours in an embodiment or about 1 to 3 hours in another embodiment. The cracking step may be carried out under conditions that can suppress the introduction of strain into the powder particles, etc.

### (3) Third Powder

The third powder is obtained through a powder annealing step for heating the second powder. The powder annealing step may be performed such that the second powder is heated at a temperature and for a time that ensure the removal of strain, stress, and the like introduced into the powder particles during the calcination step or the cracking step. The heating temperature (referred to as powder annealing temperature) is, for example, 550° C. to 850° C. in an embodiment, 650° C. to 800° C. in another embodiment, or 725° C. to 775° C. in still another embodiment. The heating time is, for example, 0.4 to 3 hours in an embodiment or 0.7 to 2 hours in another embodiment. As in the calcination step, the heating atmosphere may be an inert atmosphere or an intentional oxidizing atmosphere or the like.

### (4) Insulation Coating

The powder for magnetic cores may be composed of powder particles (soft magnetic particles) coated with insulation. The use of such a powder for magnetic cores allows a dust core to be obtained with high specific resistance and low eddy-current loss. Examples of the insulating layer formed on the surfaces of the soft magnetic particles include a resin layer, a glass layer, and an oxide layer. The resin layer is formed, for example, using silicon resin (or silicone resin) having excellent heat resistance. The glass layer is formed, for example, using low-melting-point glass or silicon resin. The oxide layer is, for example, silicon oxide (such as SiO₂) or iron oxide (such as FeO, Fe₂O₃, or Fe₃O₄) formed by heating iron alloy particles containing Si. The silicon resin, low-melting-point glass, or the like on the particle surfaces of the powder for magnetic cores not only serves as an insulating layer when the green compact is heated (annealed, etc.), but can also serves as a binding material (binder) that binds particles together. The dust core thus obtained can have not only high specific resistance but also high strength.

### «Powder for Magnetic Cores»

The powder for magnetic cores is composed of soft magnetic particles of an iron alloy containing Si. The soft magnetic particles satisfy, for example, an average particle diameter of 50 to 250 μm in an embodiment or 75 to 150 μm in another embodiment (approximately the same as that of the previously described first powder particles), an average crystal particle diameter of 30 to 100 μm in an embodiment or 45 to 75 μm in another embodiment, and an average particle hardness of 100 to 190 Hv in an embodiment or 150 to 185 Hv in another embodiment. The insulating coating of the soft magnetic particles may be formed in the stage of molding the powder for magnetic cores (stage of manufacturing the dust core), or may also be preliminarily formed.

The average crystal particle diameter as referred to in the present specification is determined as follows. First, particles classified into 106 to 150 μm from the powder are embedded in resin, polished, and etched to prepare a sample for observation. For each particle in the image obtained by observing the sample with a microscope, the cross-sectional area and the number of crystals in the particle are determined. For all the observed particles, a total (S) of cross-sectional areas is divided by a total number (N) of crystals in the particles to determine an average crystal particle cross-sectional area, thereby calculating a diameter d=2×{(S/N)/π}^{0.5} that gives the area of a circle corresponding to the average crystal particle cross-sectional area. The diameter (d) thus determined is adopted as the average crystal particle diameter.

The particles to be calculated may be all particles within a predetermined field of view (0.6 mm×0.5 mm), or may also be particles appropriately extracted from within a plurality of fields of view (e.g., about 50 to 100 particles).

The average particle hardness as referred to in the present specification is determined as follows. Using the above-described sample for observation, the hardness of 10 particles is measured at one location per particle with a micro Vickers hardness tester (test load: 100 g). The arithmetic average value of the Vickers hardness thus obtained is adopted as the average particle hardness.

The average particle hardness reflects the degree of strain and stress remaining in the soft magnetic particles. That is, it is considered that the smaller the average particle hardness, the less the strain and stress remaining in the particles (i.e., the smaller the coercive force). It is therefore considered that the use of a powder for magnetic cores having a smaller average particle hardness allows a dust core to be obtained with a smaller hysteresis loss.

### Method for Manufacturing Dust Core

The dust core is obtained, for example, by a manufacturing method that includes a filling step for filling a mold having a cavity of a desired shape with the above-described powder for magnetic cores, a molding step for pressurizing the powder to form a molded body, and an annealing step for annealing the molded body. The molding step and the annealing step are carried out, for example, as follows.

(1) The molding step can be carried out at various molding pressures, but high-pressure molding allows the obtained dust core to have a high density and a high magnetic flux density. High-pressure molding methods known in the art include a mold lubrication warm high-pressure molding method. The mold lubrication warm high-pressure molding method includes a filling step for filling a mold, in which a higher fatty acid-based lubricant is applied to the inner surface, with the powder for magnetic cores and a warm molding step for performing the molding at a temperature and a pressure at which a metal soap film other than the higher fatty acid-based lubricant is generated between the powder and the inner surface of the mold.

The term “warm” as used herein refers to setting the molding temperature (mold temperature), for example, to 70° C. to 200° C. in an embodiment or 100° C. to 180° C. in another embodiment. Details of the mold lubrication warm high-pressure molding method are described, for example, in JP3309970B and JP4024705B.

(2) The annealing step is carried out for the purpose of removing the strain and stress remaining in the particles due to the molding step. This reduces the coercive force and hysteresis loss of the dust core. The annealing temperature is appropriately selected in accordance with the composition of the powder particles, etc., but is, for example, 500° C. to 900° C. in an embodiment or 650° C. to 800° C. in another embodiment. The heating time is, for example, 0.1 to 5 hours in an embodiment or 0.5 to 2 hours in another embodiment. The annealing step is usually carried out in an inert atmosphere.

### «Dust Core»

(1) The higher the density of the dust core, the higher the magnetic characteristics it can achieve. Its relative density may therefore be, for example, 95% or higher in an embodiment, 96% or higher in another embodiment, or 96.3% or higher in still another embodiment. The relative density is the ratio (p/p₀) of the bulk density (p) to the true density (p₀).

(2) Dust cores are used in various applications and can take various forms depending on the applications. Dust cores are used as magnetic cores, for example, for electric motors (including generators), actuators, transformers, induction heaters (IH), etc.

Meanwhile, motors for electric vehicles (EVs) rotate at a higher speed than conventional ones, and attempts are being made to further reduce the size with respect to the output. Since the motors for EVs are used to drive vehicles, they are required to have low iron losses even in a low rotation region (low frequency region) in which the eddy-current loss is not dominant. The dust core of the present invention is suitable for an iron core on the field element side or armature side (in particular, stator side) of such a motor operating at a high speed. For example, according to the dust core of the present invention, the iron losses (in particular, hysteresis loss) can be reduced even in a frequency region of 3 kHz or less. In the case of a motor with eight magnetic poles, for example, frequencies of 1.2 kHz, 2.0 kHz, and 3 kHz correspond to rotation speeds (maximum rotation speeds) of 18000 rpm, 30000 rpm, and 45000 rpm, respectively.

### EXAMPLES

Dust cores were prepared using various powders for magnetic cores obtained under different treatment conditions, and their characteristics were evaluated. The present invention will be described in more detail based on such specific examples.

«Powder for Magnetic Cores»
(1) First powder (raw material powder)

A gas-atomized powder composed of a Si-containing iron alloy (Fe-3% Si) was prepared as the raw material powder. In the present examples, unless otherwise stated, the alloy composition is represented by mass ratio (mass %).

The raw material powder was classified using a sieve (mesh size: #50), and the powder having a particle size of less than 300 μm was adopted as the first powder. When the average particle diameter of the first powder was measured by the previously described particle size distribution analyzer, it was 94.3 μm (D50). For Sample 2 listed in Table 1, the raw material powder was classified into a powder having a particle size of 45 μm or more and less than 250 μm using two types of sieves (#330 and #60) with different sizes, and this powder was used as the first powder. When the average particle diameter was measured in the same manner as above, it was 100.2 μm (D50).
(2) Second powder (calcination step)

Each of the first powders (200 g) was placed in an alumina crucible and they were heated in a furnace at respective calcination temperatures listed in Table 1. In this operation, after the furnace was preheated in a vacuum atmosphere (1×10⁻² Pa×400° C.×1 hour), each of the first powders was heated at a rate of 12° C./min to the target calcination temperature in an inert atmosphere (under Ar gas flow: about 90 kPa), and they were heated at respective calcination temperatures for 1 hour. After this heating, the first powder was cooled in the furnace (allowed to cool in the furnace in the inert atmosphere).

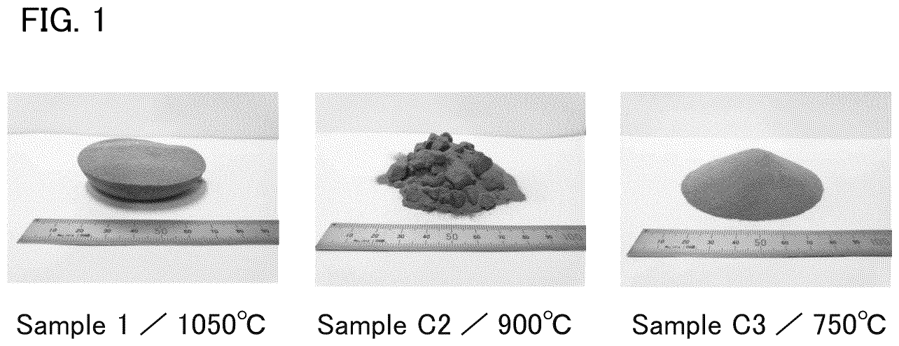

FIG. 1 shows the state of the first powder heated at each calcination temperature. As apparent from FIG. 1, only when heated at 1050° C. (975° C. or higher) (Samples 1, 2, and C1 in Table 1), a calcined body in which the first powder was fixed was obtained (calcination step).

The first powder (Sample C2 in Table 1) heated at 900° C. was placed in a mortar and lightly disintegrated to obtain a second powder. The first powder heated at 750° C. (Sample C3 in Table 1) was used as the second powder without any modification.

The calcined body obtained by heating the first powder at 1050° C. was subjected to a step (cracking step) of putting φ10 mm alumina balls (about ⅓ of the volume of a φ100 mm×100 mm ceramic pot) and 100 g of the calcined body into the ceramic pot and disintegrating the calcined body in the ball mill (100 rpm×1 hour) to obtain a second powder. It was confirmed by sieving that the particle size of each of the second powders was approximately the same as that of the first powder (less than 300 μm or less than 250 μm).

### (3) Third Powder (Powder Annealing Step)

The disintegrated second powders of Samples 1 and 2 were heated in a furnace at 750° C. The heating conditions were the same as in the above-described calcination step except for the heating temperature. The third powders according to Samples 1 and 2 were thus obtained.

### (4) Insulation Coating (Warm Kneading Step)

Each of the soft magnetic powders (Samples 1 and 2: the third powders, Samples C1 to C3: the second powders) was mixed with a resin powder (“KR220L” available from Shin-Etsu Chemical Co., Ltd.) (mixing step). The amount of the resin powder was 0.5 mass parts with respect to the soft magnetic powder (100 mass parts). The mixed powders were placed in a container, heated to soften the resin powder, and kneaded with a glass rod (130° C.×15 minutes). After that, the kneaded product was cooled to room temperature while moving the glass rod. Thus, a powder for magnetic cores composed of coated particles, in which the soft magnetic powder particles were coated with the silicone resin, was obtained. The insulating coating treatment was performed under an atmospheric pressure atmosphere.

### Dust Core

Dust cores were manufactured as follows using the above-described powders for magnetic cores.

(1) A super-hard mold having a ring-shaped cavity was prepared. The inner surface of the mold was coated with TiN and the surface roughness was 0.4 Z. The mold was preheated with a band heater to set the inner wall temperature of the cavity to 130° C.

Lithium stearate (1%) dispersed in an aqueous solution was uniformly applied to the inner surface of the cavity of the heated mold with a spray gun at a rate of about 10 cm³/min. The aqueous solution was prepared by adding surfactants and an antifoamer to water. Polyoxyethylene nonylphenyl ether (EO) 6, (EO) 10, and borate ester Emalbon T-80 were used as the surfactants. Each of these was added by 1 vol % to the entire aqueous solution (100 vol %).

FS Antifoam 80 was used as the antifoam. This was added by 0.2 vol % to the entire aqueous solution (100 vol %). Lithium stearate having a melting point of about 225° C. and a particle diameter of 20 μm was used. The amount of dispersion was 25 g per 100 cm³ of the above aqueous solution. This was further subjected to refinement treatment with a ball mill type pulverizer (Teflon (registered trademark) coated steel balls: 100 hours) to obtain a liquid concentrate. An aqueous solution having a final concentration of 1% obtained by diluting the liquid concentrate by 20 times was used for the above application.

(2) Each powder for magnetic cores was filled into the cavity after application of lithium stearate (filling step).

The filled powder for magnetic cores was compression-molded at 1600 MPa while maintaining the temperature in the cavity at a warm state of 130° C. A ring-shaped green compact (outer diameter φ39 mm×inner diameter φ30 mm×thickness 5 mm) was thus obtained.

(3) Each green compact was heated in a furnace (750° C.×45 minutes) in a nitrogen atmosphere (13.3 kPa) (annealing step). A ring-shaped dust core (material under test) was thus obtained.

### Observation/Measurement

### (1) Average Crystal Particle Diameter

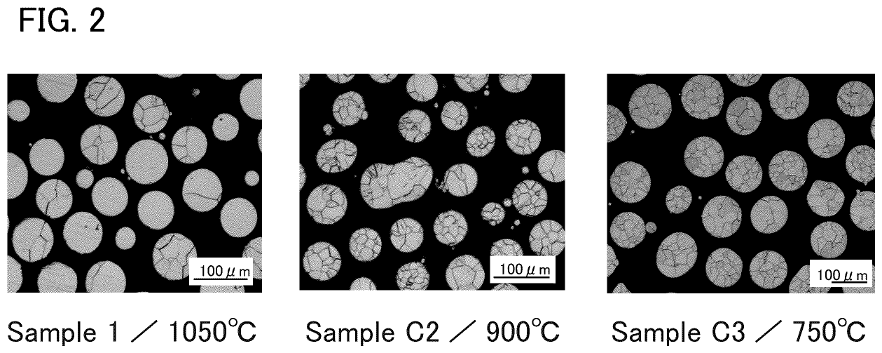

Particles extracted from each of the second powders with different calcination temperatures were embedded in a resin and etched with nital to prepare a sample for observation. The cross section was observed with a scanning electron microscope (SEM). FIG. 2 shows the observed images of Samples 1, C2 and C3.

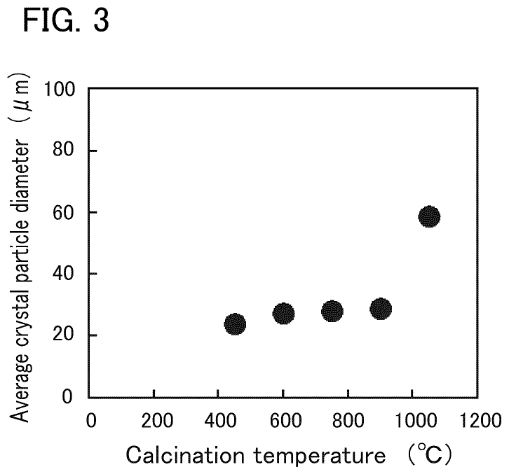

The observed image of each sample was image-processed, and the average crystal particle diameter was determined with the previously described method. The results are also listed in Table 1. FIG. 3 illustrates the relationship between the calcination temperature and the average crystal particle diameter.

### (2) Average Particle Hardness

For each of the soft magnetic powders before insulating coating (Samples 1 and 2: the third powder, Samples C1 to C3: the second powder), the average particle hardness was determined with the previously described method. The results are also listed in Table 1.

### (3) Iron Losses

A φ0.5 mm copper wire was wound around the dust core (ring-shaped) of each sample, and an AC BH analyzer (available from IWATSU ELECTRIC CO., LTD., model number: SY-8258) was used to measure the iron losses (hysteresis loss and eddy-current loss) when an AC magnetic field of 1 T, 2 kHz was applied. The results thus obtained are also listed in Table 1.

### (4) Density

For the dust core of each sample, the bulk density (p) was calculated from the measured dimensions and weight. The true density (p₀) of the dust core was also calculated based on the compounding ratio of the resin powder used for the insulating coating and the raw material powder and their true densities. The relative densities (p/p₀) of the dust cores thus determined are also listed in Table 1.

### Evaluation

### (1) Average Crystal Particle Diameter

As apparent from Table 1 and FIG. 3, it has been found that the average crystal particle diameter increases significantly in the powder particles of Samples 1, 2, and C1 with a calcination temperature of 1050° C.

### (2) Iron Losses

As apparent from Table 1, it has been found that the iron losses (in particular, hysteresis loss in a low-frequency region (e.g., 2 kHz)) decrease significantly in the dust cores (Samples 1 and 2) each composed of the third powder subjected to the cracking and powder annealing after the calcination at a high temperature. It has also been found that the powder particles of Samples 1 and 2 have lower average particle hardness than other powder particles.

### (3) Consideration

The reason why the iron losses of the dust cores of Samples 1 and 2 are small is considered as follows. The powder particles of Samples 1 and 2 were in a state in which the crystals in the particles grew in the calcination step, and the residual strain and stress introduced during the cracking of the calcined bodies were removed in the powder annealing step. It is thus considered that such powder particles have a small coercive force, and the hysteresis loss of the dust core composed of such powder particles is also significantly reduced.

From the above, it has been confirmed that the use of the powder for magnetic cores according to the present invention can reduce the iron losses of the dust core (in particular, the hysteresis loss in the low-frequency region).

TABLE 1

| | | | Characteristics of powder | | Characteristics of dust core | | | |
|---|---|---|---|---|---|---|---|---|
| | | | Average | | | Losses (1T, 2 kHz) | | |
| | Manufacturing conditions for powder | | crystal | | | | | Eddy- |
| | Calcination | Presence or | particle | | Relative | | Hysteresis | current |
| Sample | temperature | absence of | diameter | Hardness | density | Iron loss | loss | loss |
| No. | (° C.) | powder annealing | (μm) | (Hv) | (%) | (kW/m³) | (kW/m³) | (kW/m³) |
| 1 | 1050 | Present | 57.8 | 181 | 96.5 | 859 | 673 | 186 |
| 2 | 1050 | (750° C.) | 57.8 | 181 | 96.6 | 834 | 667 | 167 |
| C1 | 1050 | Absent | 57.8 | 199 | 95.6 | 956 | 794 | 162 |
| C2 | 900 | | 28.4 | 193 | 96.1 | 1085 | 923 | 163 |
| C3 | 750 | | 27.5 | 203 | 93.4 | 1785 | 1644 | 141 |

1. A method for manufacturing a powder for magnetic cores, comprising:
a calcination step for heating a first powder composed of an iron alloy containing Si at 975° C. to 1175° C. to obtain a calcined body;
a cracking step for disintegrating the calcined body to obtain a second powder; and
a powder annealing step for annealing the second powder to obtain a third powder.

2. The method for manufacturing a powder for magnetic cores according to claim 1, wherein the powder annealing step includes heating the second powder at 550° C. to 850° C.

3. A powder for magnetic cores that is composed of an iron alloy containing Si,
the powder comprising soft magnetic particles satisfying an average particle diameter of 50 to 250 μm, an average crystal particle diameter of 30 to 100 μm, and an average particle hardness of 100 to 190 Hv.

4. The powder for magnetic cores according to claim 3, wherein the iron alloy contains 1 to 4 mass % of Si with respect to the iron alloy as a whole.

5. The powder for magnetic cores according to claim 3, wherein the soft magnetic particles are coated with insulation.

6. A dust core obtained by molding the powder for magnetic cores according to claim 3.

7. The dust core according to claim 6, used in an alternating magnetic field with a frequency of 1 to 3 kHz.
